(19) United States
(12) Patent Application Publication
(10) Pub. No.: US 2015/0135637 A1
(43) Pub. Date: May 21, 2015

(54) METHOD AND APPARATUS FOR INSERTING HURRICANE TIE-DOWNS OVER ROOF FRAMING WITHOUT HAVING TO REMOVE SHEATHING

(71) Applicant: Robert Platts, Ottawa, CA (US)

(72) Inventor: Robert Platts, Ottawa, CA (US)

(21) Appl. No.: 14/082,164

(22) Filed: Nov. 17, 2013

(51) Int. Cl. E04G 23/00; B66F 11/00; B66F 15/00; E04B 1/41

(52) U.S. Cl. CPC E04G 23/00; E04B 1/40; B66F 11/00; B66F 15/00
USPC 52/745.21; 254/100; 254/131.5

(57) ABSTRACT

It's now accepted that hurricane tie-down straps should be wrapped over the top of rafters/trusses, avoiding the crucial weakening effect of wood splitting around the nails of common side-nailed straps. That “wrap-over” is easy to do during construction but has been difficult and costly to do for existing houses, where the sheathing and roofing is in the way. But now such wrap-over can be an easy retrofit, according to this invention: Without damaging sheathing or roofing, force the sheathing off the rafter/truss just enough to allow a special strap to be pushed through the gap, then proceed much as in new construction. Unique wedge-blade and lever types of devices quickly create just the right gaps.

### TECHNICAL FIELD

The present invention relates to reinforcing the wood roof structures of existing houses and similar low-rise buildings against wind uplift by means of a retrofitting method and apparatus for securing roof frames to walls without having to remove roofing/sheathing.

### BACKGROUND OF THE INVENTION

While today's steel strap connectors excel for new construction of houses and like small buildings for securing wood roof structures to their supporting walls, they are not readily applicable to retrofitting existing structures. Such strap “ties” or “tie-downs” should have an upper portion extending over the top of a roof frame (rafter or truss) to ensure adequate tie-down strength by applying much of the restraining force onto the top of the roof frame as compression across the grain, which wood withstands quite well. If the tie-down connectors are simply nailed into the side of the roof frame—as commonly done until recent years—localized tensions are induced across the grain of the wood during nailing or especially under load, such that the rafter/truss member tends to split under hurricane-force uplifts, releasing the tie-downs' nails too easily—often much before the “design load” is reached.

The over-the-top or “wrap over” tie-down method is now widely recommended or required in the US Hurricane Belt for new construction, and even for retrofits of existing buildings. It's easily done in new construction: the roof frame and supporting wall is entirely accessible before the roof sheathing is applied. During retrofitting, however, accessing the top portion of the rafter/truss requires removal and re-installation of an area of roofing and sheathing; such a laborious and costly operation discourages such retrofit upgrading of existing housing and building stock altogether, leaving the stock needlessly vulnerable.

There have been recent efforts to devise methods for retrofit reinforcement of wood roof structures. Some steel tie-down examples simply provide more area aligned with the roof slope to allow insertion of more nails through the strap and into the side of the rafter/truss, but that can exacerbate splitting under load (and indeed the very act of crowding nails into the ultra-dry wood encountered in existing houses is seen to cause especially extensive splitting, even “shredding”).

Considerable older retrofit thinking does try to avoid such splitting. In U.S. Pat. No. 5,257,483 Netek discloses ways of installing anchor points in roof fascias and the wall surfaces below, allowing temporary placement of ties in the event of an impending storm. Winger, in U.S. Pat. No. 5,319,816, and several other inventors, disclose other temporary arrangements using multiple cables or nets over the roof which are anchored to the ground. Such temporary devices demand that the householder be at home and ready to react to storm warnings. In U.S. Pat. No. 5,311,708, Frye shows a retrofit roof tie-down method in which lag screws are installed upwardly through an angled steel plate into the bottom edge of the rafters/trusses, but costs and load transfer distortions are problematic.

Accordingly, I have devised and tested a “slant toggle” tie down (U.S. Pat. No. 7,562,494 Jul. 21, 2009), which involves drilling a hole slantingly upwards through the roof frame so that a tie can run through to emerge near the top, just under the sheathing, and be there secured to restrain the roof frame against upward movement. That, however, involves precisely angled drilling from below and awkward insertion of a clip just under the sheathing. Therefore I devised and tested a “claw” device, slope-adjustable, featuring a sharp-edged top flange hammered into the interface between frame and sheathing to apply its restraining force top-down on the roof frame (U.S. patent application Ser. No. 12/607,154, Oct. 28, 2009). That claw device proves difficult to insert in some cases, however, and is intrinsically somewhat costly. The need remained clear: devise a better retrofit over-the-top tie-down method and apparatus to upgrade existing buildings to the strength achieved by applying over-the-top strap ties in new construction.

The concept in this invention is to force the sheathing just a little off the roof frame, allowing over-the-top insertion of a tie-down strap much as practiced in new construction. It's neither an obvious nor readily practicable approach: Any kind of sledging or hammering the sheathing upward tends to puncture or smash it and/or lift it off too much, the latter itself leaving it unacceptably bulged upward and perhaps with a significantly large area poorly fastened to the roof framing. On the other hand, trying to pry or wedge the sheathing up by driving say a broad chisel between it and the top edge of the roof frame roof involves awkward and misaligned driving (the sheathing interfering with the chisel's proper stance—and sheathing and neighboring rafters/trusses interfering with a hammer's swing), and even if somehow doable can cut into the roof sheathing or roof frame or hit a roofing nail.

### SUMMARY OF THE INVENTION

A method and apparatus is provided for reinforcing the connection of an existing roof frame to a wall or like structure below it, which comprises a) lifting just a small area of the roof sheathing off the roof frame just sufficiently to allow b) inserting a head end of a tie-down strap (the strap) into the gap on one side of the roof frame and completely inward over the frame's top edge, and with the lifting means and amount reliably set to avoid damage to sheathing or frame or the hold of one to the other; then c) pushing the head end of the strap further to protrude beyond the top far edge of the roof frame sufficiently to allow d) bending the protruding portion of the strap tightly down over the far edge and onto the far side of the roof frame far enough to accept sound fastening there; and finally e) driving fasteners such as nails or screws through that bent-down portion of the strap and into the far side of the roof frame, so that the strap itself (when its tail is fastened in prior-art manner on the near side of the roof frame too, and secured to the wall below) must apply much of its restraining force downward into the top of the roof frame, so that wood splitting forces are minimized and any such splitting during installation or under uplift load will have minimal weakening effect on the strap's restraining strength.

It will be clear that the strap itself should differ from prior art straps, in that its head end should be angled flatwise outward from the main axis of the rest of the strap so that when protruding beyond the top far edge of the roof frame and bent downward it is oriented outward, despite the usual slope of the top of the roof frame, and so remains outboard of any potentially interfering framing (such as common “blocking” between roof frames) and is accessible for fastening operations such as nailing or screwing into the far side of the roof frame.

It will be clear that the strap itself should differ from prior art straps, in that its head end should be angled flatwise outward from the main axis of the rest of the strap so that when protruding beyond the top far edge of the roof frame and bent downward it is oriented outward, despite the usual slope of the top of the roof frame, and so remains outboard of any potentially interfering framing (such as common “blocking” between roof frames) and is accessible for fastening operations such as nailing or screwing into the far side of the roof frame.

In accordance with one embodiment of the present invention, the lifting of the roof sheathing off the roof frame is accomplished by driving a sharp-pointed wedge squarely into the interface between the top of the roof frame and the underside of the roof sheathing and then across much of said top, preferably using a worm gear or ratchet type of drive, the wedge and drive being mounted in a horizontally oriented bar (hereinafter the device being named the “bar wedge”), which bar is adjustably fitted between that roof frame and the next with its opposing end restrained by the near side of the next roof frame; whereby the driving of the wedge of a certain thickness lifts the roof sheathing to provide just a sufficient gap off the roof frame's top alongside the wedge to allow full insertion and thence deployment of the over-the-top tie-down strap.

There being many sheathing nails and some roofing nails intruding through the roof sheathing into the top of the roof frame, with perhaps a 1:8 chance of one happening to intrude into the path of the advancing wedge across the top of the roof frame, a means of evading such an obstruction is provided according to the invention by having the point and head end portion of the wedge divided into at least two prongs, each prong being pointed so that even if one hits the nail the wedge need only sidestep slightly as it proceeds across the top of the roof frame, the nail being accommodated between prongs or alongside the wedge.

In a second embodiment of the present invention, called the U-wedge, the lifting of the roof sheathing off the roof frame is accomplished by positioning a first wedge squarely against the first side and a second wedge squarely against the opposite side of the roof frame, the two wedges being directed toward each other into the interface between the top of the roof frame and the underside of the roof sheathing, each wedge being equipped with a worm gear or ratchet type of drive and each such assembly being integrally mounted on a vertical arm of a U frame which fits up over the sides of the roof frame from below to provide exact positioning and restraint for the wedges; thence driving both wedges into that interface toward each other with each being capable of advancing across much of the top of the roof frame, so that if an obstructing sheathing or roofing nail brings one wedge to a premature stop the other wedge can continue being driven toward the stopped wedge across the remaining top of the roof frame until that other wedge is also stopped by the nail, the wedges then intruding across almost all of the top of the roof frame and just sufficiently lifting the roof sheathing therefrom.

In a further embodiment of the invention the lifting of the roof sheathing off the roof frame is accomplished by positioning a lever assembly near one side of the roof frame where it crosses the supporting wall, and preferably a second lever assembly near the other side of the roof frame, each such lever assembly having a fulcrum seated solidly on the supporting wall near its exterior surface or on the blocking often present atop that wall, a short load arm projecting inward from that fulcrum to a lifting end set against the underside of the roof sheathing, and a long effort arm extending outward, whereby pushing down on the lever's effort arm exerts a multiplied force upwards at the lifting end against the underside of the roof sheathing to force the roof sheathing off the roof frame just the amount needed for passage of the tie-down strap. Excessive lifting is prevented by the downswing arc of the lever's effort arm being limited by the wall's exterior surface below, the short length of the lever's load arm and the shape of the lever's load tip being such that said limited downswing can only lift the load tip a desired amount.

These and other features and advantages of the present invention, my “Strapeze™” invention, will be better understood with reference to preferred embodiments described hereinafter.

### BRIEF DESCRIPTION OF THE DRAWINGS

Reference will now be made to the accompanying drawings showing by way of illustration preferred embodiments of the present invention, each being a method/device for lifting a small area of roof sheathing slightly off the top of a roof frame in a controlled, practicable manner.

FIG. 1 is a front elevational view of a bar wedge device placed horizontally between roof frames and with its top surface against the underside of the roof sheathing.

FIG. 2 is a partial front elevational view of the operative wedge portion of the bar wedge with cutouts showing the driving gear inside, the wedge itself being in its retracted position.

FIG. 3 is a partial front elevational view of the operative wedge portion of the bar wedge with cutouts showing the driving gear inside, the wedge extended.

FIG. 4 is a plan view of the wedge divided into two prongs to enable it to to sidestep an obstructive nail.

FIG. 5 is a partial side elevational section of a wedge driven under the roof sheathing, showing the gap made between the top of the roof frame and the sheathing with a tie-down strap using that gap.

FIG. 6 is a side elevational view of a lever assembly in place in the typical case where a blocking is present between roof frames.

FIG. 7 is a front elevational view of a fulcrum plate for the lever assembly.

FIG. 8 shows cross sections of a lever bar.

FIG. 9 is a perspective view of a pair of lever bars connected for convenient use together.

FIG. 10 is a side elevational view of a lever assembly in place in a common case where there's no blocking between roof frames.

FIG. 11 is a front elevational view of a U wedge device pushed up over a roof frame.

FIG. 12 is a perspective view of the operative wedge portion of the U wedge device mounted on one vertical arm of the U-bar.

FIG. 13 shows various views of a tie-down strap and the roof frame with the leading end of the tie-down strap formed at an angle to one side to avoid interference from blocking and roof sheathing when being fastened to the far side of the roof frame.

### DETAILED DESCRIPTION OF PREFERRED EMBODIMENTS

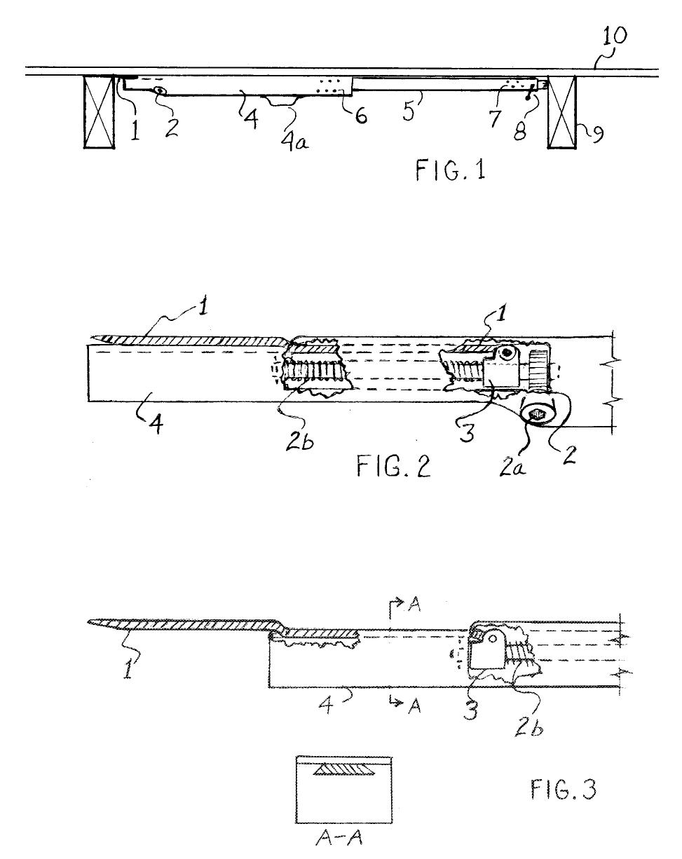

First, FIGS. 1 to 5 illustrate the bar wedge device held up against the underside of the sheathing and directing the wedge tip straight into the interface between sheathing and the top of the roof frame.

In FIG. 1, a side elevation of the bar wedge device is shown ready to work, with the wedge 1 poised with its tip at the interface between a left side roof frame 9 and the roof sheathing 10. A driving device 2 is set in the backbone 4 of the wedge. The handle 4a is useful for setting the device at ready, while a telescoping extension 5 is approximately adjusted by means of setting a pin in the group of holes 6 and more finely 7, while a cam or gear adjuster 8 pushes teeth into the right side roof frame 9.

FIG. 2 is a side elevation of just the front end of the bar wedge device, showing the wedge 1 (still retracted) connected to a worm gear drive 2b and 2 by means of a traveler 3, ready for operation by means of a crank (not shown) which drives the worm gear and traveler by turning the worm gear 2 through the receptacle 2a.

In FIG. 3, the wedge 1 is shown driven forward by the traveler 3 pushed by the worm gear 2 and 2a, so that the wedge would now be fully extended over the top of the roof frame to force up the roof sheathing (not shown), while the other end of the bar wedge would push against the right side roof frame (not shown). Section AA shows the cross section of the bar 4, shaped to guide the driving end of the sliding wedge 1. (Once the strap has been inserted, as in FIG. 5, the wedge can be withdrawn by the traveler 3 on the worm gear 2 and 2a; this retraction also takes considerable force.)

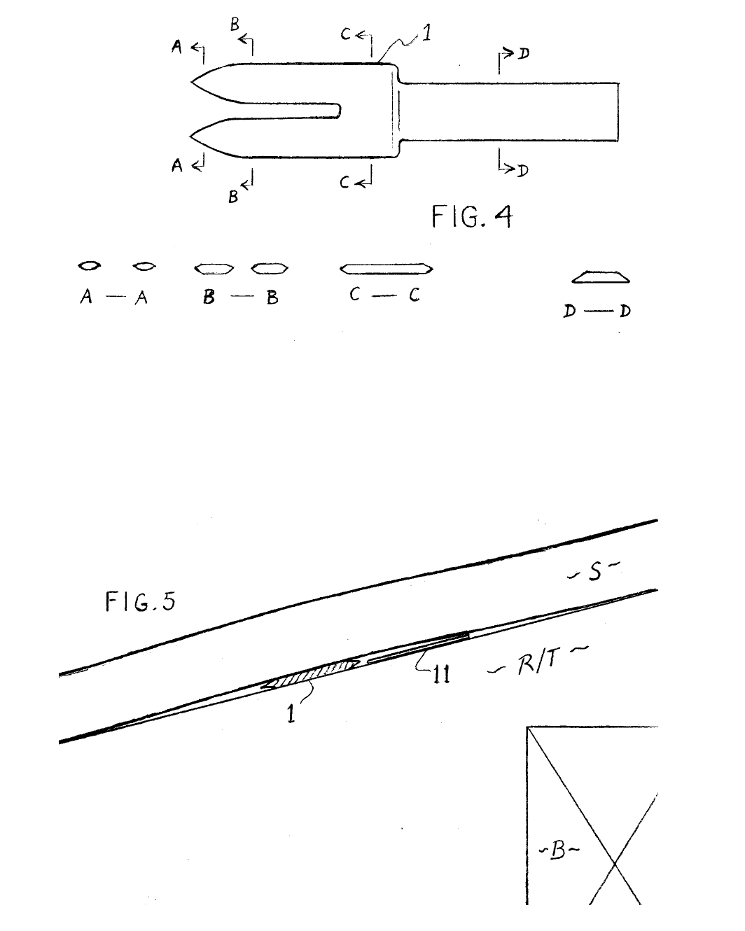

FIG. 4 shows a preferred design of the wedge 1, illustrating the two-prong forked wedge with each prong pointed. This forked and pointed design comes crucially into play whenever the advancing wedge hits a sheathing nail (which will happen often, such nails generally being driven into the roof frame only 10 or 15 cm. apart). A prong hitting a nail will force the advancing wedge to move slightly sideways (also the end of the bar 4 of course, FIGS. 2 and 3—which bar end moves easily sideways since it's being pushed away from the roof frame being wedged). The wedge can thereby advance past the nail with the nail to one side or in the gap between the prongs; thus the wedge's sideways movement need never exceed half the width of one prong (typically being less than 1 cm. sideways). The sections A-A, B-B and C-C show how the wedge's edge shape facilitates sidewise sliding as the wedge moves forward; neither sheathing nor roof frame is cut by the motion and the forces are moderate. Section D-D shows how the wedge's pushed end is shaped to fit into and be securely guided by the bar's section A-A of FIG. 3.

FIG. 5 is a sketch of the wedge 1 fully engaged, showing the wedged-open gap allowing insertion of a tie-down strap on either side of the wedge. The dashed lines 11 indicate where the strap might preferably be located. The driving worm gear 2 is engaged by a power driver or hand crank 2c, all angled downward for easy operation. Once the strap is inserted—with no need to wait for it to be fastened—the drive train 2c and 2 is operated in reverse to retract the wedge and move the bar wedge device to the next roof frame position. The sheathing's remaining “bulge” of about 3 mm or less is not visible on the generally shingled surface above, nor is there significant weakening of the sheathing's hold-down to the roof frame.

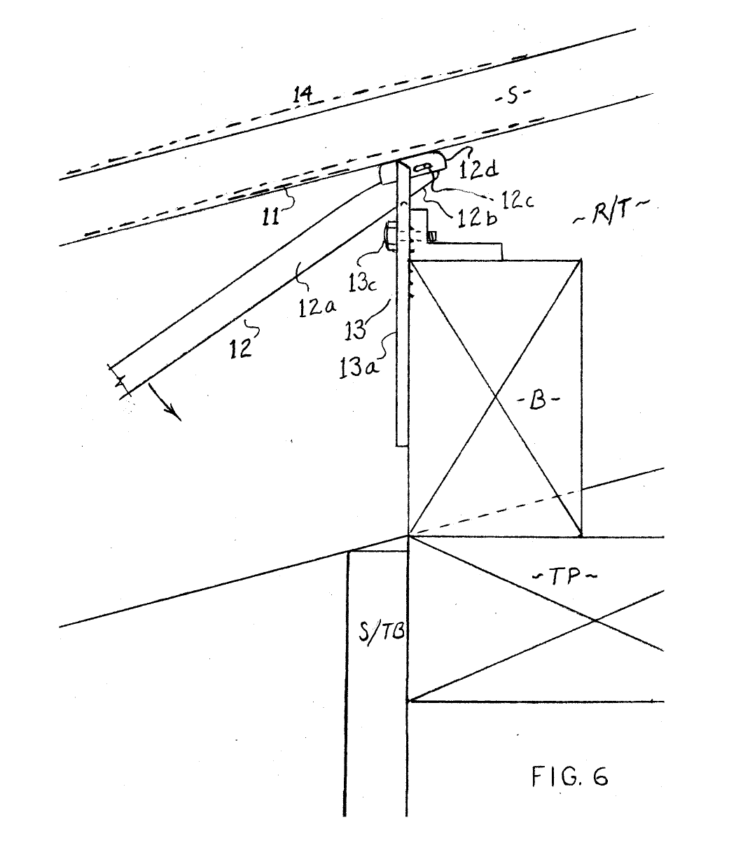

Next, FIGS. 6 to 9 illustrate a lever device with a fulcrum assembly resting on the top of the “blocking” generally affixed atop the wall between roof frames.

In FIG. 6, TP is wall top plate on which a wood blocking member B is set, in general practice, fixed between roof frames R/T (rafter or truss) at each end, and sized to leave a certain vent gap between the top of blocking B and the underside of the roof sheathing S. A lever 12 has been inserted into the venting space to bear on the top of a fulcrum assembly 13 which has been seated on the blocking B, so that pushing downward (arrow) on the lever's effort arm 12a causes the load tip 12b to push upward against the underside of the roof sheathing S. That push is transferred by way of a bearing pad 12d, which pad (affixed to the lever's load tip 12b by a pin 12c) acts as a “load spreader” allowing great force upwards on the roof sheathing S without unduly stressing it in compression across the grain. The roof sheathing S is thereby forced off the frame R/T, with the resulting gap 14 allowing insertion and adjustment of a tie-down strap 11 (dashed line) over the top edge of the frame R/T.

Preferably two such lever setups are used for each such sheathing lift, with a fulcrum assembly 13 set alongside each side of an R/T and with a pair of lever bars lifting the sheathing at both points simultaneously, as noted below.

The lever device lifts the roof sheathing just enough to allow passage of a tie down strap over the top of the roof frame, as follows: The fulcrum assembly 13 is adjusted so that the actual fulcrum (the top of the plate 13a) is a certain distance below the underside of the roof sheathing S (a distance preferably set by “horns” 13d, as shown below); the geometry is such that the lever's load tip 12b can lift the pad 12d just a certain amount, no more, as the lever's effort arm is pushed down through the available arc which is limited by the wall below; further, when the lever bar is tilted down past a certain angle it will simply slide downward across the fulcrum, friction being overcome. It can be shown that such controlled lifting is obtained, creating the correct gap 14, with a range of roof slopes from flat to say 7:12 slope. Almost all roofs in “hurricane country” are sloped within this range. Moreover, where steeper slopes are encountered the typical side-nailed straps generally suffice even for retrofit purposes, the force on their nails or screws being more aligned with the grain of the wood and much less likely to cause splitting under load—so lifting for over-the-top tie straps is not needed.

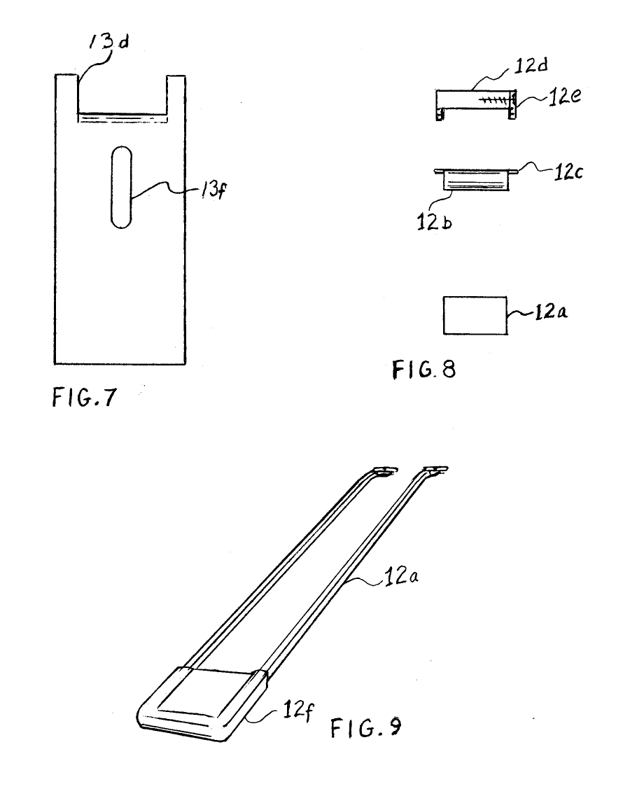

FIG. 7 is a front elevational view of the fulcrum plate 13a, showing one or perhaps two protruding “horns” 13d which set its closeness to the roof sheathing, and the slot 13f which allows such adjustment.

In FIG. 8, cross sections are shown of the lever bar 12a and its load tip 12b, the latter having small pins 12c ready to hold onto the pad 12d (as seen in FIG. 6), which pad has one side 12e attached by a screw as shown, in this embodiment, so that the side 12e can be attached to secure the pad 12d to the lever's load tip 12b.

FIG. 9 shows a preferred paired arrangement wherein two lever setups are operated as one, joined as shown by a member 12f. As noted above, one fulcrum 13 is seated close by one side of a roof frame, a second fulcrum close by the other side of same, so that the paired lever setups can simultaneously apply lifting force against the roof sheathing at each such side, to lift effectively with least strain on the roof sheathing. The sheathing's “plate action” helps form a smoothly arched lift (gap 14 in FIG. 6).

Testing has shown that both the wedge and lever devices work well to lift roof sheathing off a roof frame, whether the roof sheathing is formed of wood boards as in older houses or of modern plywood. The recent OSB forms (Oriented Strand Board) have not been tested but they're generally found in the “hurricane belt” only in newer houses already using “wrap over” tie down straps.

The two distinct “Strapeze™” devices, the wedge and the lever, should be discussed further at this point.

The wedge can be placed between two adjacent R/Ts close to the wall line, but also 1) farther outboard where appropriate for certain types of tie-down straps. Not so with the lever. Conversely, the wedge is usable where roof frames are normally spaced apart (from 16″ o.c. to 24″ o.c., generally) but not where close together (e.g. where three in a group offer no space of at least 16″ o.c. on either side of the middle one requiring retrofit tie-down). Many houses have at least one such condition. There, the lever would be needed. (Skipping retrofitting of just one of such close-together R/Ts would often be acceptable engineering-wise, real-world-wise . . . but not likely to the eyes of an inspector or the letter of a building code, where acceptability and simple physics may not be related.) Further, the wedge might be somewhat awkward to handle and use on a scaffold, and perhaps a little slow in operation.

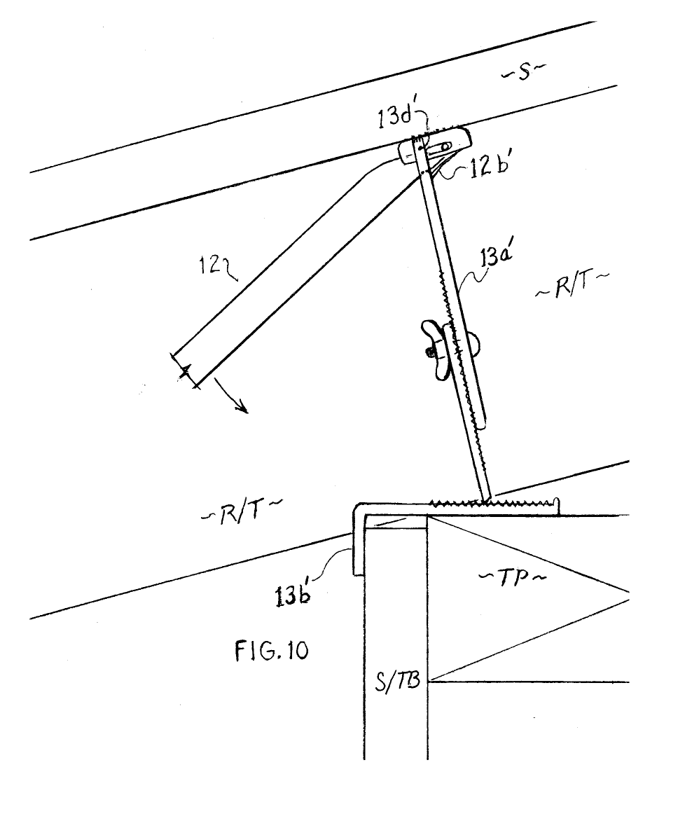

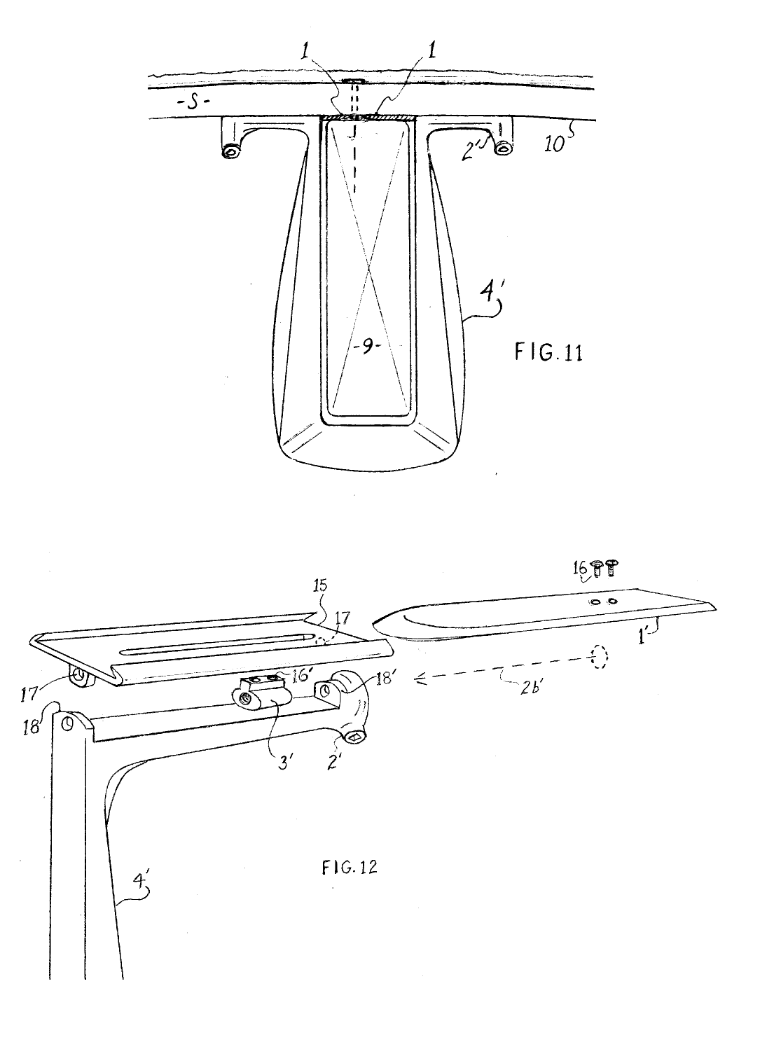

FIG. 10 illustrates the lever apparatus adapted for the common case where there's no blocking between roof frames atop the wall. Here the fulcrum 13a′ is formed of two plates adjustably fixed together to extend from the underside of the roof sheathing S to the wall top TP, regardless of the height of the (typical) roof frame. The bottom edge of the fulcrum plates 13a′ is set on and pulled forward on the base plate 13b′ atop the wall plate TP, but clearly the base plate 13b′ does not itself hold the fulcrum plate 13a′ upright. Therefore the uppermost plate in this case is formed with two horns 13d′(as better depicted in FIG. 7, 13d), and their points are serrated so as to bite into the underside of the roof sheathing until lifting begins. In a further variation from the lever assembly of FIGS. 6 and 7, the underside of the load tip 12b′ is here so shaped or fitted with a spring-like keeper that, once the roof sheathing is forced off the horns 13d′ the shape or keeper of the load tip 12b′ restrains the top of the fulcrum plates 13a′ from falling inward, the lever's load tip itself being set forcefully against the underside of the roof sheathing S during the lifting.

FIG. 11 is a side elevation of a “U Wedge” embodiment of the invention, complementary to or replacing the wedge of FIGS. 1-6 and the lever of FIGS. 7-9. It enables retrofit-strapping of even close-together roof frames—whether or not they have blocking between them. (Being similar in its operating parts to the wedge, the U Wedge parts are here numbered similarly, differentiated only by the prime symbol.) Two wedges 1′ are forced by worm gear drives 2′ into the interface between a roof frame 9′ and a roof sheathing 10′, one wedge driven from one side of the frame 9′ and one from the other side, the driving gear 2′ being supported by a rigid clamp-like U-piece 4′ which is positioned to surround the roof frame 9′.

Where the wedge uses narrow prongs to allow it to move past a sheathing nail—requiring some sidewise movement—the U Wedge need not: An advancing wedge hitting a nail (the left one in this sketch) simply stops, the extra resistance being sensed by the installer, while the opposing wedge is driven further across until hitting the same nail from the other side or simply until completing the lifting of the roof sheathing. (Nails may be encountered often enough, as noted earlier, but never more than one in any one wedge path.)

FIG. 12 is an exploded perspective of one operative portion of the U Wedge, right hand side, where the U-piece 4′ is shown supporting the worm gear 2′ and the guide 15 for the wedge 1′, which is shown ready for insertion into the guide 15. As in the wedge, the traveler 3′ is driven forward or retracted by the drive 2b′ (dashed line, not yet installed). The traveler 3′ in turn drives the wedge 1′ (attached to it by means of the screws 16 installed in the holes 16′, in this example).

Whereas the bar wedge can be placed to fit against any normal roof slope, the U Wedge must itself be positioned more or less vertically, so its wedges must rotate to fit into the interface between roof sheathing and sloping roof frames. Accordingly, the guide 15 is mounted on the U-piece 4′ by means of the drive 2b′ through the holes 17, thus being freely hinged to rotate when pressed against the underside of the roof sheathing (not shown here). The rotation is here limited by the end protusion 18 and similar shelf 18′.

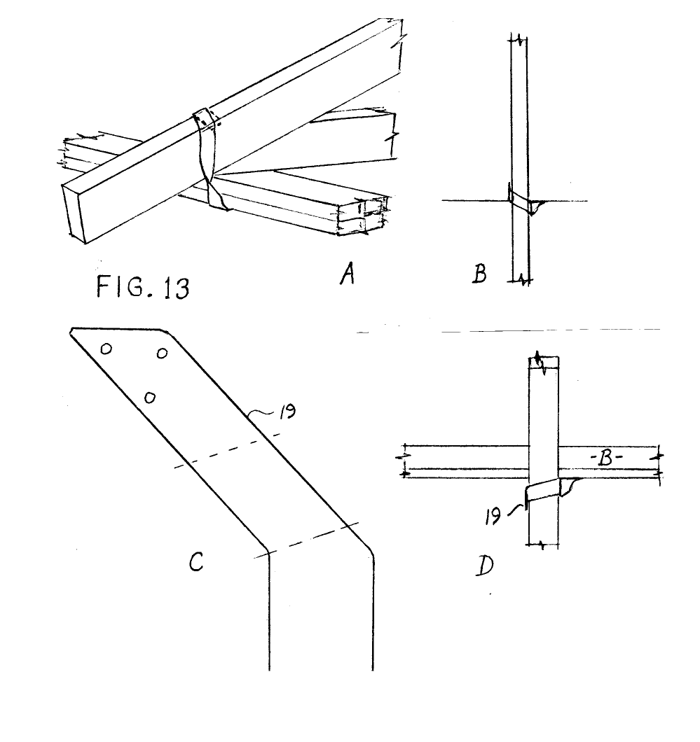

In FIG. 13, final aspects of over-the-top (“wrap-over”) retrofitting are addressed. First, it can be seen in FIGS. 13A and B (looking straight down on the roof frame, in B, with the wall plane indicated below the strap), that the off-side portion of a conventional tie down strap becomes positioned inboard of the wall plane, which is fine in new construction because the roof sheathing is not yet in place and there's lots of room for bending the strap down and driving fasteners there. In our retrofitting operation, however, the roof sheathing is in the way, and there's often blocking interfering too. Accordingly, the tie down strap should feature a diverted end portion 19, FIG. 13C, to ensure that the inserted wrap over offers its end outboard of the wall plane. (The faint lines beside the strap end 19 are intended only to show that such angled strap can still be punched out of flat metal, with very little waste.) In FIG. 13D (again looking straight down on the roof frame) it can be seen that the diverted “wrap-over” 19 of the tie-down strap is directed outward from the wall plane and the blocking B, thus being accessible for fastening.

Finally, in any such retrofitting, the strap's tail cannot readily be anchored to the wall's framing (as often so easily done in new construction, as seen in FIG. 12A), but must lap down over and be fastened onto whatever forms the outer face of the top portion of the wall. Where that face is a plywood sheathing, say, fully adequate fastening can readily be done. Where there's no such strong sheathing present, a Top Band™ of plywood can first be installed around the house perimeter, itself nailed solidly into the wall framing underneath, and ready to hold the strap's nailing securely and transfer the uplift forces rather directly into the house framing. Such a Top Band could simply be ⅝ in. thick by 8-12 in. wide fir plywood, for example, and all of this work would be hidden when the soffit panels are replaced on the greatly strengthened house.

I claim:

1. A method of reinforcing the connection of an existing roof structure to a supporting wall by installing a tie-down strap with its upper end over the top of a roof frame without having to remove the roof sheathing and roofing covering said frame, comprising steps of:
pushing upwards on the sheathing from below, close beside at least one side of the roof frame and above the exterior surface of the supporting wall, thereby lifting the sheathing just enough off the roof frame to provide a pathway for the strap over the top of the roof frame, the manner and amount of lift not significantly damaging the sheathing or its attachment to the roof frame;
inserting the head end of the tie-down strap into the pathway at a near side of the roof frame and pushing it across the top of the roof frame to extend beyond the far side;
bending the extended portion of the strap down over the far side of the roof frame sufficiently far to accept fastening into that next side, the strap being designed with its head end so skewed outward that it remains accessible under the roof overhang for such fastening;
fastening the tail end of the tie-down strap down the near side of the roof frame and down over the wall below in conventional manner, enabling the strap to restrain the roof frame against wind uplift by applying much of its restraining force downward into the top of the roof frame so that any existing splits or splitting of the roof frame under uplift load will have minimal if any weakening effect on the strap's ultimate restraining capacity.

2. A method according to claim 1 wherein the lifting of the roof sheathing off the roof frame is accomplished by positioning a sharp-pointed wedge blade squarely against the first side of the roof frame above the outside of the supporting wall, with the sharp point of the wedge blade directed into the interface between the top of the roof frame and the underside of the roof sheathing, then driving the wedge blade into that interface and across much of the top of the roof frame, the thickness of the wedge blade limiting its lifting of the sheathing to provide just a sufficient gap off the roof frame's top alongside the wedge blade to form a pathway for insertion and deployment of the tie-down strap as in claim 1.

3. A method according to claim 2 whereby a roofing nail happening to be in the path of the advancing wedge blade across the top of the roof frame is evaded by having the sharp point and head end portion of the wedge blade divided into at least two prongs, each prong being pointed so that even if one hits the nail the wedge blade need only sidestep slightly as its blade proceeds across the top of the roof frame, the nail being accommodated between prongs or alongside the wedge blade.

4. A method according to claim 1 whereby the lifting of the roof sheathing off the roof frame is accomplished by positioning a first wedge blade squarely against the near side and a second wedge blade squarely against the far side of the roof frame, each wedge blade having its sharp point directed into the interface between the top of the roof frame and the underside of the roof sheathing, then driving both wedge blades into that interface toward each other with each being capable of advancing across much of the top of the roof frame, so that if an obstructing roofing nail brings one wedge blade to a premature stop the other wedge blade can continue being driven toward the stopped wedge blade across the remaining top of the roof frame until that other wedge blade is also stopped by the nail, the wedge blades then intruding across almost all of the top of the roof frame and sufficiently lifting the roof sheathing therefrom.

5. A method according to claim 1 whereby the lifting of the roof sheathing off the roof frame is accomplished by positioning a lever assembly near one side of the roof frame where it crosses the supporting wall and preferably a second lever assembly near the other side of the roof frame, each such lever assembly having a fulcrum seated solidly on the supporting wall, a short load arm leading inward from that fulcrum to a lifting end set against the underside of the roof sheathing, and a long effort arm extending outboard of the wall, whereby pushing down on the lever's effort arm exerts a multiplied force upwards at the lifting end against the underside of the roof sheathing to force the roof sheathing off the roof frame just the amount needed for passage of the tie-down strap.

6. A wedge apparatus for forcing a small area of roof sheathing slightly off the top of a roof frame, comprising:
a wedge blade having a length of about twice the thickness of the roof frame, a sharp point across its forward end so shaped as to push into the interface between the roof frame and the roof sheathing without cutting into the surface of either, and of a width sufficient to limit the wedge's pressure against the roof sheathing's underside and the roof frames' top so as not to indent or otherwise unduly damage the wood of either as the wedge is driven forward between them;
a track piece retaining the wedge blade in one plane and one alignment while allowing it to be slid forward a distance of about the width of the roof frame beyond the end of the track piece, and to be retracted similarly;
a worm gear mounted in the track piece and connected to the bar wedge so that operation of the worm gear can push the wedge blade forward from its fully retracted position with great force, and can retract it fully;
a supportive frame consisting of an adjustable bar assembly securing or integral with the track piece at its forward end and terminating in a blunt shape at its opposite end, the bar assembly and wedge blade being aligned and their top surfaces being in the same plane, and the bar being of a telescoping or like construction so that its overall length can be adjusted to fit between two roof frames as typically spaced apart in wood frame construction;
whereby the top of the wedge apparatus with its retracted wedge blade is positioned against the underside of the roof sheathing just above and parallel to the supporting wall so that, regardless of roof slope, the sharp tip of the wedge blade fits against the interface between the top of the roof frame and the underside of the roof sheathing on one side of the roof frame and close beside the intended position of the tie-down strap; the whole apparatus being held there by adjusting the bar length until its blunt end is pressed tightly against the side of the neighboring roof frame, the apparatus then allowing the worm gear to be operated to drive the wedge blade into the interface and thence across the roof frame top to lift the sheathing off the roof frame to provide a gap just sufficient for inserting a wrap-over tie-down strap over the top of the roof frame without removing or unduly damaging the roof sheathing or its attachment to the roof frame.

7. A wedge apparatus according to claim 6 for forcing a small area of roof sheathing slightly off the top of a roof frame, comprising:
a first wedge blade assembly with track piece and worm gear as in claim 6 positioned on a first side of the roof frame against the underside of the roof sheathing just above and parallel to the supporting wall so that the sharp point of the wedge blade is poised at the interface between the top of the roof frame and the underside of the roof sheathing, close beside the intended position of the tie-down strap;
a second such wedge blade assembly positioned on the opposite side of the roof frame against the underside of the roof sheathing just above and parallel to the supporting wall so that the sharp tip of the wedge blade is poised at the interface between the top of the roof frame and the underside of the roof sheathing, close beside the intended position of the tie-down strap, aiming directly toward the tip of the first wedge blade;
a supportive frame shaped in a U form having two vertical arms integral with a bottom piece which spaces the arms apart sufficiently to be moved upwardly around a roof frame from below, each arm securing one of the wedge blade, track piece and worm gear drive assemblies as in claim 6 while allowing the wedge blade to rotate around its long axis so as to fit flatly against the underside of the roof sheathing regardless of roof slope, and the supportive frame's vertical arms being long enough to accommodate the depth of typical roof frames and hold the wedge blade assemblies against the underside of the sheathing;
wherein the wedge apparatus with both wedge blades retracted is positioned against the underside of the roof sheathing just above and parallel to the supporting wall so that the sharp tip of each wedge blade fits against the interface between the top of the roof frame and the underside of the roof sheathing, the first wedge blade being on one side of the roof frame and close beside the intended position of the tie-down strap and the second wedge blade being on the opposing side of the roof frame and similarly positioned, the apparatus then allowing the two worm gears to be operated to drive the wedge blades into the interface from opposite ends toward each other across the roof frame top to lift the sheathing off the roof frame to provide a gap just sufficient for inserting a wrap-over tie strap over the top of the roof frame without removing or unduly damaging the roof sheathing or its attachment to roof frame.

8. A lever apparatus for forcing a small area of roof sheathing slightly off the top of a roof frame, comprising:
a fulcrum assembly consisting of a first plate and a second plate poised somewhat vertically and held flatwise against each other to act as one strut, the first plate having its top edge as the actual fulcrum and having its side edges forming small “horns” extending a certain amount higher past each end of that fulcrum, and the second plate being fixed adjustably to the first plate so that with the uppermost tips of the horns touching the underside of the roof sheathing and so shaped as to bite slightly into said underside, the lower edge of the second plate extends downward to reach solid bearing typically on the top of the supporting wall's top plate or on the top of blocking between roof frames where such blocking is present: said fulcrum assembly being placed near a first side of a roof frame with its horns aligned parallel to and above the outer surface of the wall below; the second plate's bottom edge being supported by a base piece consisting of a horizontal plate placed atop such solid bearing and having an outer flange reaching sufficiently downward over the wall's or the blocking's outside vertical surface so that the base piece can not slide inwardly; and the top surface of the base piece's horizontal plate preferably being so grooved as to hold the bottom edge of the second plate from sliding inwardly, once that bottom edge has been forced forward sufficiently to tighten the vertical plates into position with the horn's tips preferably being sharpened to bite slightly into the underside of the roof sheathing;
a lever assembly having a load tip shaped to fit snugly under the roof sheathing over the fulcrum and sufficiently inwardly to form a certain load arm, and with an effort arm extending outwardly under the roof overhang where it can be pushed manually downward to force the load tip strongly upward, with the load tip either so shaped that it spreads its upward force over an area of the roof sheathing's underside sufficient to avoid undue denting of same, or alternatively with the load tip being capped by a load-spreading rigid pad to ensure same; and having the load tip's underside either so shaped or fitted with a spring-like keeper as to help prevent the fulcrum from slipping inwardly off said underside;
whereby pushing down on the lever's effort arm through an arc limited by the wall below leverages the lever's load tip upward to lift a small area of the roof sheathing harmlessly off the roof frame's top, thereby, preferably acting in concert with an essentially identical lever apparatus installed and similarly pushing upward on the roof sheathing on the opposite side of the roof frame, creating a gap just sufficient to allow the installing of a tie-down strap over said top of the frame without having to remove the roof sheathing and roofing.
